(19) United States
(12) Patent Application Publication
(10) Pub. No.: US 2011/0266408 A1
(43) Pub. Date: Nov. 3, 2011

(54) Method for joining a rubber mount or a rubber-metal mount with a bearing seat and a chassis mount

(75) Inventor: PETER KOCZAR, Wiesbaden (DE)

(73) Assignee: Benteler Automobiltechnik GmbH, Paderborn (DE)

(21) Appl. No.: 13/082,027

(22) Filed: Apr. 7, 2011

(30) Foreign Application Priority Data
Apr. 8, 2010 (DE) 10 2010 014 257.3

(51) Int. Cl. F16M 13/02; B29C 65/64

(52) U.S. Cl. 248/309.1; 156/293

(57) ABSTRACT

Method for joining a rubber mount or a rubber-metal mount (3) to a bearing seat (2) of a chassis mount (1), wherein the rubber mount or the rubber-metal mount (3) is pressed into the bearing seat (2), wherein the rubber mount or the rubber-metal mount (3) is adhesively bonded to the bearing seat (2) after being pressed in, and a chassis mount (1) with a rubber mount or a rubber-metal mount (3) pressed into a bearing seat (2), wherein the rubber mount or the rubber-metal mount (3) is adhesively bonded to the bearing seat (2).

The invention relates to a method for joining a rubber mount or a rubber-metal mount to a bearing seat of a chassis mount having the features in the preamble of claim 1 and a chassis mount having the features in the preamble of claim 6.

Chassis mounts are used to provide a control and isolation function of a chassis of an automobile. Chassis mounts in form of elastic joints are here installed in axle systems and control arms. The chassis mounts are typically coaxially arranged coated rubber-metal mounts with a metallic bearing core. The bearing core is connected to the chassis with screws. At least one rubber or elastomer layer is vulcanized to the bearing core. The rubber-metal mount produced in this way is pressed into a bearing seat, for example of a control arm of the chassis under elastic pretension of the rubber layer. In addition, according to the state-of-the-art, multilayer rubber-metal mounts having metal layers are arranged between the elastomer layers can be used to improve the response and the acoustics.

Disadvantageously, after the rubber-metal mount in conventional chassis mounts is pressed into the bearing seat, relative movements with respect to the bearing seat can still occur, which produces objectionable friction and damping. Wear of the chassis mount also increases.

Starting from this state-of-the-art, it is an object of the invention to provide a method for producing a chassis mount, wherein the relative movement between a rubber mount or a rubber-metal mount and a bearing seat can be prevented, as well as to provide a chassis mount wherein relative movements between the rubber mount or the rubber-metal mount and the bearing seat are prevented.

The part of the object relating to the method is attained with a method having the features of claim 1.

Advantageous embodiments and features of the invention are recited in the dependent claims.

With the method according to the invention for joining a rubber mount or a rubber-metal mount with a bearing seat of a chassis, the rubber-metal mount is pressed into the bearing seat. The rubber layer bordering the bearing seat is hereby compressed. Adhesive is applied to a surface of the bearing seat and/or to a surface of the rubber layer facing the bearing seat, so that the rubber mount or the rubber-metal mount is adhesively bonded to the bearing seat after being pressed in and hence materially connected with the bearing seat.

The adhesive is preferably applied to the surface of the bearing seat and/or the surface of the rubber mount or of the rubber-metal mount before the rubber mount or the rubber-metal mount is pressed in. It is also possible to apply the adhesive to the respective surfaces while the rubber mount core the rubber-metal mount is pressed into the bearing seat. The term rubber mount or rubber-metal mount in the context of the present invention relates to the mount part that is pressed into the bearing seat. By pressing the rubber mount or the rubber-metal mount into the bearing seat, a uniform two-dimensional press fit is attained in a joining region. In this way, the bearing seat is uniformly joined with the rubber mount or the rubber-metal mount across the joint region.

Pure rubber mounts are preferably constructed in tubular form and are connected with a metal component, for example a bearing seat, by using the adhesive process according to the invention.

When using rubber-metal mounts with several rubber layers, a bearing core can also be materially joined with an interior rubber layer of the rubber-metal mount by an adhesive process with this method. The adhesive is hereby applied to an exterior circumferential surface of the bearing core and/or to a surface of an interior rubber layer facing the bearing core. This also ensures full-surface contact between the rubber layer and the bearing core when the bearing core is pressed in and hence uniform adhesive bonding between the bearing core and the interior rubber layer.

The adhesive used may be part of the group of contact adhesives, acrylate adhesives or epoxy resin adhesives. Preferably, a natural rubber adhesive can also be employed.

By adhesively bonding the bearing seat with a rubber mount or a single-layer or multilayer rubber-metal mount, a material connection is produced which prevents relative movement in the contact region between the rubber mount or the rubber-metal mount and the bearing seat. Pressing the rubber mount or the rubber-metal mount in also produces a uniform two-dimensional press fit between the bearing seat and the rubber mount or the rubber-metal mount. This has in turn a positive effect on the uniformity of the adhesive joint.

The part of the object relating to the device is attained with a chassis mount having the features of claim 6.

The chassis mount according to the invention includes a rubber mount or a rubber-metal mount pressed into a bearing seat. The rubber mount or the rubber-metal mount is hereby joined to the bearing seat by an adhesive process. The thus produced material connection between the bearing seat and the rubber mount or the rubber metal mount prevents relative movement between the rubber mount or the rubber-metal mount and the bearing seat in the contact region.

In addition, when using a rubber-metal mount with several rubber layers, an interior rubber layer can also be adhesively joined to the bearing core. The bearing core is hereby likewise pressed into the rubber-metal mount, whereby the interior rubber layer is compressed so as to produce a uniform area press fit between the rubber layer and the bearing core, resulting in uniform adhesion in the joint region.

By adhesively bonding the rubber mount or the rubber-metal mount in the bearing seat, it would also be feasible to employ bearing seats with geometries that deviate from the circular tube shape, so that the circumferential surface of the rubber mount or the rubber-metal mount does not completely contact a surface oriented from the bearing seat to the rubber mount or the rubber-metal mount. It is only important in this context that sufficient adhesive surface is available to ensure adequate adhesion between the rubber mount or the rubber-metal mount and the bearing seat.

The invention will now be described in more detail with reference to two exemplary embodiments which are schematically shown in the Figures. It is shown in:

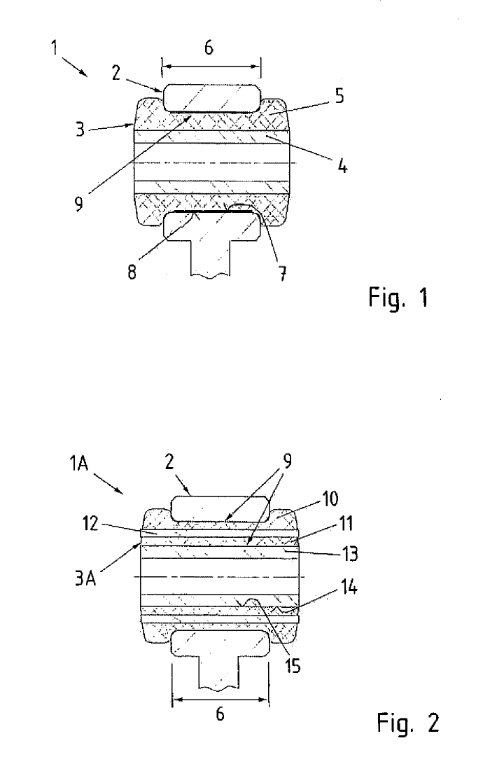

FIG. 1 a simple rubber-metal mount in a bearing seat, and

FIG. 2 a rubber-metal mount with an intermediate layer.

FIG. 1 shows a chassis mount 1 with a bearing seat 2 and a rubber-metal mount 3. This rubber-metal mount 3 has a bearing core 4 and a rubber layer 5. The rubber-metal mount 3 is hereby pressed into the bearing seat 2. In other words, the rubber layer 5 is compressed in a joint region 6 between the bearing seat 2 and the rubber-metal mount 3, thereby ensuring a uniform two-dimensional press fit between bearing seat 2 and the rubber-metal mount 3. A material connection between the bearing seat 2 and the rubber-metal mount 3 is produced in the joint region 6 by adhesive bonding.

Adhesive bonding is produced by applying an adhesive 9 on a surface 7 of the bearing seat 2 facing the rubber-metal mount 3 and/or on a surface 8 of the rubber layer 5 facing the bearing seat 2, with the adhesive 9 adhesively bonding the bearing seat 2 and the rubber-metal mount 3 after pressing.

The adhesive bond counteracts a possible relative movement of the rubber-metal mount 3 relative to the bearing seat 2 during the operation of the chassis mount 1.

FIG. 2 also shows a chassis mount 1A with a multilayer rubber-metal mount 3A having two rubber layers 10, 11 which is pressed into a bearing seat 2. In this embodiment, the rubber layers 10, 11 are separated from one another by a metallic intermediate layer 12. The rubber-metal layer 3A is here likewise pressed into the bearing seat 2 and adhesively bonded to the bearing seat in the joint region 6.

In addition, the bearing core 13 of the multilayer rubber-metal mount 3A is also materially joined with an adhesive to a rubber layer 11 of the rubber-metal mount 3A. The adhesive 9 is here also applied on an exterior circumferential surface 14 of the bearing core 13 and/or on a surface 15 of the interior rubber layer 11 facing the bearing core 13, thereby adhesively bonding the bearing core 13 with the rubber layer 11 of the multilayer rubber-metal mount 3A after pressing.

### LIST OF REFERENCES SYMBOLS

1 Chassis mount

1A Chassis mount

2 Bearing seat

3 Rubber-metal mount

3A Rubber-metal mount

4 Bearing core

5 Rubber layer

6 Joint region

7 Surface

8 Surface

9 Adhesive

10 Rubber layer

11 Rubber layer

12 Intermediate layer

13 Bearing core

14 Circumferential surface

15 Surface

1.-9. (canceled)

10. A method for joining a rubber mount or a rubber-metal mount to a bearing seat of a chassis mount, comprising the steps of:
applying an adhesive on a surface of the bearing seat facing the rubber mount or the rubber-metal mount or applying the adhesive on a surface of the rubber mount or of the rubber-metal mount facing the bearing seat, or both,
pressing the rubber mount or the rubber-metal mount into the bearing seat, and
adhesively bonding the rubber mount or the rubber-metal mount to the bearing seat after pressing.

11. The method of claim 10, wherein the adhesive is applied before the rubber mount or the rubber-metal mount is pressed into the bearing seat.

12. The method of claim 10, wherein the adhesive is applied while the rubber mount or the rubber-metal mount is pressed into the bearing seat.

13. The method of claim 10, wherein a bearing core is adhesively bonded to the rubber mount or to a rubber layer of the rubber-metal mount.

14. The method of claim 10, wherein the adhesive is selected from the group consisting of contact adhesive, acrylate adhesive and an epoxy resin adhesive.

15. A chassis mount, comprising:
a bearing seat,
a rubber mount or a rubber-metal mount pressed into the bearing seat, and
an adhesive applied between the rubber mount or the rubber-metal mount and the bearing seat to provide an adhesive bond between the rubber mount or the rubber-metal mount and the bearing seat.

16. The chassis mount of claim 15, further comprising a bearing core adhesively bonded to the rubber mount or to a rubber layer of the rubber-metal mount.

17. The chassis mount of claim 15, wherein the bearing seat has a geometry that deviates from a circular shape.

18. The chassis mount of claim 15, wherein the rubber-metal mount comprises a plurality of rubber layers which are separated from one another by an intermediate layer.
